(19) United States
(12) Patent Application Publication
(10) Pub. No.: US 2021/0042005 A1
(43) Pub. Date: Feb. 11, 2021

(54) TOUCH MODULE AND TOUCH DISPLAY APPARATUS WITH STRUCTURE OF DISPLAY COMPENSATING AGAINST TOUCH FUNCTION REQUIREMENTS

(71) Applicant: HON HAI PRECISION INDUSTRY CO., LTD., New Taipei (TW)

(72) Inventors: YU-FU WENG, New Taipei (TW); HUNG-YUN HUANG, Hsinchu (TW)

(21) Appl. No.: 16/670,142

(22) Filed: Oct. 31, 2019

(30) Foreign Application Priority Data
Aug. 5, 2019 (CN) 201910718952.X

(51) Int. Cl. G06F 3/041

(52) U.S. Cl. CPC G06F 3/04164

(57) ABSTRACT

A touch display apparatus with display function able to compensate for touch function effects includes N electrodes covered by an insulating layer, first connection lines, and second connection lines. The insulating layer defines through holes at regions corresponding to the electrode blocks. The first to (M−1)th electrode blocks are respectively connected to the second connection lines. The Mth to Nth electrode blocks are respectively connected to the first connection lines. The Mth electrode block is connected to the first connection line through the through holes in a first specified number. The (M+1)th to Nth electrode blocks are connected to the first connection line in a second specified number.

### FIELD

The subject matter herein generally relates to touch display apparatus.

### BACKGROUND

Electronic device with a display function and a touch function is widely used for performing a human-computer interaction. The electronic device includes electrodes and a driver coupled to the touch electrodes through lines. Due to a distance difference between electrodes and the driver, the lines connected to the electrodes are in different length, thus resistances of the lines are different. The resistance difference between two adjacent electrodes will affect a display performance of the electronic device, for example, when displaying a horizontal line.

There is room for improvement in the art.

### BRIEF DESCRIPTION OF THE FIGURES

Implementations of the present disclosure will be described, by way of embodiment, with reference to the figures.

FIG. 1 is a schematic view of an embodiment of a touch display apparatus, the touch display apparatus comprising a touch module and a driver coupled to the touch module.

FIG. 2 is a planar view of the touch module and the driver of FIG. 1.

FIG. 3 is a cross-section view along line of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “substantially” is defined to be essentially conforming to the particular dimension, shape, or other feature that the term modifies, such that the component need not be exact. For example, “substantially cylindrical” means that the object resembles a cylinder but can have one or more deviations from a true cylinder. In general, the word “module,” as used herein, refers to logic embodied in hardware or firmware, or to a collection of software instructions, written in a programming language, for example, Java, C, or assembly. One or more software instructions in the modules may be embedded in firmware, such as an EPROM, magnetic, or optical drives. It will be appreciated that modules may comprise connected logic units, such as gates and flip-flops, and may comprise programmable units, such as programmable gate arrays or processors, such as a CPU. The modules described herein may be implemented as either software and/or hardware modules and may be stored in any type of computer-readable medium or other computer storage systems. The term “comprising” means “including, but not necessarily limited to”; it specifically indicates open-ended inclusion or membership in a so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.” Embodiments of the present disclosure are described with reference to the drawings.

The present disclosure describes a touch display apparatus for decreasing a difference in resistance between two connection lines connected to two adjacent electrodes.

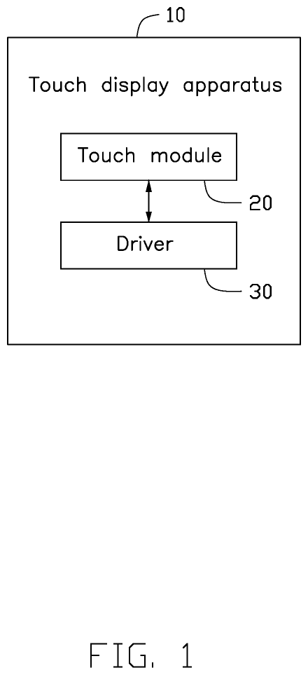

FIG. 1 shows a touch display apparatus 10. The touch display apparatus 10 can be a consumer electronic device, such as a mobile phone or a computer, and can be a touch display monitor in a smart device. The touch display apparatus 10 includes a touch module 20 and a driver 30 coupled to the touch module 20. The touch module 20 senses touch operations of users under the control of the driver 30.

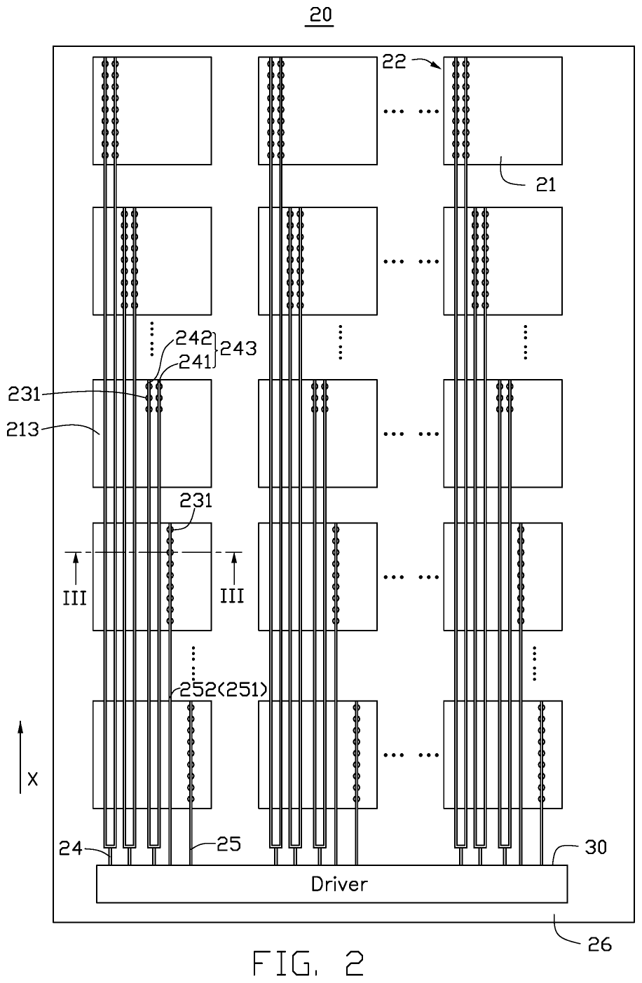

In one embodiment, the touch module 20 is an in-cell touch module. FIG. 2 shows a planar view of the touch module 20. The touch module 20 includes a substrate 26 and electrode blocks 21 disposed on the substrate 26. Each electrode block 21 is made of transparent conductive material. In one embodiment, each electrode block 21 serves as a common electrode, which serves as a display electrode and a touch electrode in different time periods. The electrode blocks 21 are arranged in a matrix. In one embodiment, the electrode blocks 21 in a column are arranged along a first direction X, and the electrode blocks 21 in a line are arranged along a second direction perpendicular to the first direction X. In one embodiment, an electrode column 22 includes the electrode blocks 21 arranged along the first direction X, and a number of the electrode blocks 21 in each electrode column 22 is constant. The electrode columns 22 are separated from each other by a specified distance.

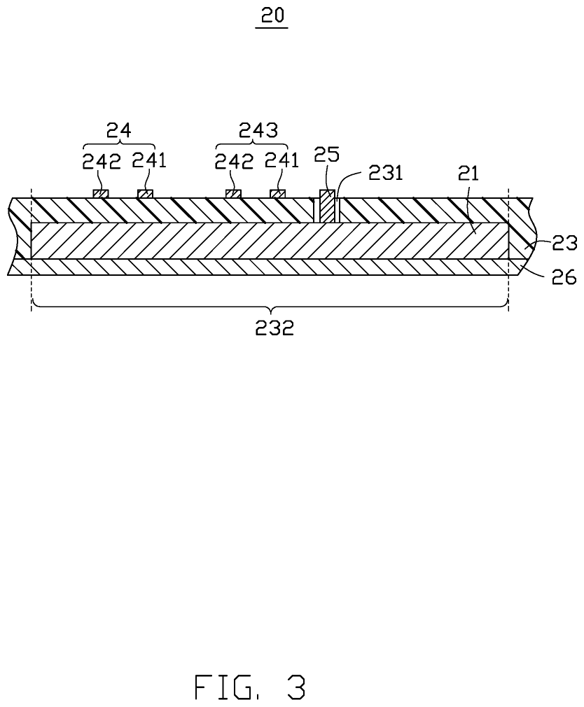

FIG. 3 shows a cross-section view of the touch module 20. The touch module 20 further includes an insulating layer 23. The insulating layer 23 covers the electrode blocks 21. The insulating layer 23 defines through holes 231 at regions 232 facing the electrode blocks 21. Each electrode block 21 corresponds one of the regions 232 of the insulating layer 23, and the through holes 23 are disposed at the corresponding region 232 of the insulating layer 23. The regions 232 of the insulating layer 23 are the regions where projections of the electrode blocks 21 are disposed on the insulating layer 23 along a light emitting direction. As shown in FIG. 3, the region 232 corresponds to the projection of the electrode block 21 on the insulating layer 23.

Referring to FIGS. 2-3, the touch module 20 further includes first connection lines 24 and second connection lines 25. The first connection lines 24 and the second connection lines 25 are disposed on a surface of the insulating layer 23 facing away from the electrode blocks 21. Each first connection line 24 is connected to the corresponding electrode block 21 through at least one of the through holes 231, and each connection line 25 is connected to the corresponding electrode block 21 through at least one of the through holes 231. Thus, each electrode block 21 is electrically connected either with one of the first connection lines 24 or with one of the second connection lines 25.

Referring to FIG. 2, the driver 30 is disposed on a side of the electrode blocks 21. The driver 30 connects with the first connection lines 24 and the second connection lines 25. The driver 30 outputs touch signals to the electrode blocks 21 through the first connection lines 24 and the second connection lines 25 and receives touch sensing signals from the electrode blocks 21 for detecting the touch operations of users.

Referring to FIG. 2, each electrode column 22 includes N electrode blocks 21. In each electrode column 22, distances between the electrode blocks 21 and the driver 30 are gradually increased from the first electrode block 21 to the Nth electrode block 21. In each electrode column 22, a minimum distance is the distance between the driver 30 and the first electrode block 21 provided next to the driver 30, and a maximum distance is the distance between the driver 30 and the Nth electrode block 21 placed away from the driver 30. In each electrode column 22, the first to (M−1)th electrode blocks 21 are respectively connected to the second connection lines 25, and the Mth to Nth electrode blocks 21 are respectively connected to the first connection lines 25. M is less than N and is larger than 1. M and N are integer numbers.

In one embodiment, in each electrode column 22, two third of the electrode blocks 21 are respectively connected to the first connection lines 24, and one third of the electrode blocks 21 are respectively connected to the second connection lines 25. This means that M−1 is equal to N/3.

Due to the connections between the electrode blocks 21 and the driver 30 through the first connection lines 24 or the second connection lines 25, the greater the number of the electrode blocks 21, the larger is the length of the first connection line 24 or the second connection line 25 connected to the electrode blocks 21 away from the driver 30. Thus, a resistance of the first connection line 24 or the second connection line 25 is larger, and a transmitting loss of the signal on the first connection line 24 or the second connection line 25 also becomes larger, which affects a display performance of the touch display apparatus 10.

For reducing the transmitting loss, in one embodiment, each first connection line 24 includes two conductive lines 241, 242 connected in parallel, thus the constant distance between the electrode block 21 and the driver 30 reduces the resistance of the first connection line 24. In one embodiment, each second connection line 25 of the electrode block 21 adjacent to the driver 30 is one single conductive line 251. In one embodiment, a resistance of the conductive line 241, 242 is equal to a resistance of the single conductive line 251. Thus, the resistance of each conductive line 241, 242 with a specified length is equal to the resistance of the single conductive line 251 in the specified length.

In one embodiment, the projections of the through holes 231 on the electrode block 21 are defined as electrical connection points. A length of the first connection line 24 or the second connection line 25 is a distance between the driver 30 and the electrical connection point adjacent to the driver 30, which is on the corresponding electrode block 21 being connected to the first connection line 24 or the second connection 25. For example, the Nth electrode block 21 includes nine electrical connected points arranged in a line along the first direction X and is connected to the first connection line 24. The length of the first connection line 24 is a distance from the driver 30 to the electrical connection point closest to the driver 30.

Referring to FIG. 2, in the Mth to Nth electrode blocks 21 of each electrode column 22, a difference in length between two adjacent first connection lines 24 is equal to a sum of a width of the electrode block 21 along the first direction X and a distance between two adjacent electrode blocks 21 along the first direction X. In the product as used, the distance between two adjacent electrode blocks 21 is small, and the width of the electrode block 21 is also small. Thus, the difference in length between two adjacent first connection lines 24 is minor. Further, the first connection lines 24 have a constant resistance, thus the resistance difference between two adjacent first connection lines 24 of the Mth to Nth electrode blocks 21 is minor. In the first to (M−1)th electrode blocks 21 of each electrode column 22, a length difference between two adjacent second connection lines 25 is minor, and the single conductive line 251 of the second connection line 25 is a constant resistance, thus the resistance difference between two adjacent second connection lines 25 of the first to (M−1)th electrode blocks 21 is minor. Further, the distance between two adjacent electrode blocks 21 is constant, thus the resistance difference between two adjacent first connection lines 24 of the Mth to Nth electrode blocks 21 is also constant. There is a very small difference between the resistance difference of the two adjacent first connection lines 24 and the resistance difference of the two adjacent second connection lines 25. This very small difference has a minor effect on the performance of the touch display apparatus 10 and is invisible to users.

Referring to FIG. 2, in each electrode column 22, the (M−1)th electrode block 21 is adjacent to the Mth electrode block 21. The (M−1)th electrode block 21 is connected to the second connection line 252, and the Mth electrode block 21 is connected to the first connection line 243. A length difference between the first connection line 243 and the second connection line 252 is minor, thus the length difference has a minor effect on a resistance difference between the first connection line 243 and the second connection line 252. The first connection line 243 includes two conductive lines 241, 242 connected in parallel. The second connection line 252 includes a single conductive line 251. Resistances of the conductive lines 241, 242 and the single conductive line 251 are equal to each other. Thus, a resistance difference between the first connection line 243 and the second connection line 252 is larger than the resistance difference between two adjacent second connection lines 25 of the first to (M−1)th electrode blocks 21, and is also larger than the resistance between two adjacent first connection lines 24 of the Mth to the Nth electrode blocks 21. In detail, the resistance of the second connection line 252 is larger than a resistance of the first connection line 243.

If the resistance difference between the first connection line 243 and the second connection line 252 is suddenly increased, this will cause abnormal display of horizontal lines of the touch display apparatus 10.

Thus, in one embodiment, the number of the through holes 231 connected between the electrode block 21 and the first connection line 243 are adjusted for increasing the length of the first connection line 243, and the resistance of the first connection line 243 is increased. Thus, a difference in resistance between the first connection line 243 and the second connection line 252 is reduced.

In one embodiment, each electrode column 22 of the touch module 20 is in a same structure. The structure of one of the electrode columns 22 is explained as below, the other electrode columns 22 are the same.

Referring to FIG. 2, in one electrode column 22, other first connection lines 24 besides the first connection line 243 are respectively connected to one of the electrode blocks 21 through the through holes 231 in a constant number, and the conductive lines 241, 242 in each first connection line 24 are respectively connected to the corresponding electrode block 21 through the through holes 231 in a constant number.

In one electrode column 22, the first connection line 243 is connected to the Mth electrode block 213 through the through holes 243 in a first specified number, and other first connection lines 24 are respectively connected to one of the (M+1)th to Nth electrode blocks 21 through the through holes 231 in a second specified number. The first specified number is less than the second specified number. The first specified number is less than 120, and the second specified number is less than or equal to 120.

Since the first specified number is less than the second specified number, the positions of the through holes 231 corresponding to the first connection line 243 can be moved away from the driver 30, and the electrical connection point closest to the driver 30 is also moved away from the driver 30. Thus, the distance between the driver 30 and the electrical connection point closest to the driver 30 is increased. The length of the first connection line 243 is thereby increased and the length of the first connection line 243 is proportional to the resistance of the first connection line 243, thus the resistance of the first connection line 243 is also increased. The resistance of the second connection line 252 adjacent to the first connection line 243 is unchanged, thus a resistance difference between the first connection line 243 and the second connection line 252 is decreased.

In the touch module 20, the number of the through holes 231 connected to the first connection line 243 and the electrode block 213 is dependent on the resistances and the lengths of the conductive lines 241, 242, and the single conductive lines 251. In one embodiment, the number of the through holes 231 must be enough to keep the resistance difference of the first connection line 243 and the second connection line 252 within 200Ω.

It can be understood that, the number of the through holes 231 corresponding to the first connection lines 24 and the second connection lines 25 in FIG. 2 is an example but is not so limited. In one embodiment, the first connection line 243 is connected to the electrode block 21 through twenty through holes 231 (the first specified number is 20), each first connection line 24 in the electrode column 22 beside the first connection 243 is connected to the electrode block 21 through one hundred and twenty through holes 231 (the second specified number is 120).

When a position, location, size, or depth of the through hole 231 does not satisfy a requirement, the through hole 231 can be disabled. When some of the through holes 231 on the first connection lines 24 and the second connection lines 25 are disabled, the first connection lines 24 and the second connection lines 25 still connect to the electrode block 21 based on the through holes 231 which are enabled, for ensuring a function of the touch module 20.

The touch display apparatus 10 includes the touch module 20. The touch module 20 includes a plurality of electrode blocks 21 arranged in a matrix. The matrix includes a plurality of electrode columns 22. In each electrode column 22, the (M+1)th to Nth electrode blocks 21 are respectively connected to the first connection lines 243. The Mth electrode block 21 is connected to a first connection line 243 through the first specified number of through holes 231. The (M−1)th electrode block 21 is connected to the second connection line 252 through a second specified number of through holes 231. The (M−1)th electrode block 21 is adjacent to the Mth electrode block 21, and a resistance difference between the first connection line 243 and the second connection line 252 is larger than a resistance between two adjacent first connection lines 243 or two adjacent second connection lines 252, and the first specified number is less than the second specified number for increasing a resistance of the first connection line 243. Thus, the ordinary structure of the electrode blocks 21 and the driver 30 means that a resistance difference between the first connection line 243 and the second connection line 252 is reduced, and display performance of the touch display apparatus 10 with the touch module 20 is improved.

While various and preferred embodiments have been described the disclosure is not limited thereto. On the contrary, various modifications and similar arrangements (as would be apparent to those skilled in the art) are also intended to be covered. Therefore, the scope of the appended claims should be accorded the broadest interpretation so as to encompass all such modifications and similar arrangements.

1. A touch module in a touch display apparatus; the touch module comprising:
a matrix of electrode blocks comprising at least two electrode columns, each electrode column comprising N electrode blocks;
an insulating layer covered on the electrode blocks; the insulating layer with through holes at regions corresponding to the electrode blocks;
first connection lines disposed on a layer of the insulating layer facing away from the electrode blocks, and each first connection line configured to connect with one of the electrode blocks through the through holes; and
second connection lines disposed on a layer of the insulating layer facing away from the electrode blocks, and each second connection line configured to connect with one of the electrode blocks through the through holes;
wherein in one electrode column, the first to (M−1)th electrode blocks are respectively connected to the second connection lines, and the Mth to Nth electrode blocks are respectively connected to the first connection lines; the number of the through holes of the Mth electrode block connected to the first connection line is in a first specified number, the number of the through holes of each of the (M+1)th to Nth electrode blocks connected to the first connection lines is in a second specified number; the first specified number is less than the second specified number; M is less than N, and is larger than 1; M and N are integers;
wherein each first connection line comprises two conductive lines in parallel connection, the number of the conductive lines in each first connection line is constant the second connection line is a single conductive line; the conductive lines and the single conductive line are of a constant resistance.

2. (canceled)

3. The touch module of claim 1, wherein each first connection line has a specified number of the conductive lines.

4. The touch module of claim 1, wherein each electrode column has a specified number of the electrode blocks; a number of the electrode blocks connected to one of the first connection lines in one electrode column is equal to a number of the electrode blocks connected to one of the first connection lines in another electrode column; a number of the electrode blocks connected to one of the second connection lines in one electrode column is equal to a number of the electrode blocks connected to one of the second connection lines in another electrode column.

5. The touch module of claim 4, wherein in each electrode column, two thirds of the electrode blocks are respectively connected to the first connection lines, and one thirds of the electrode blocks are respectively connected to the second connection lines.

6. The touch module of claim 1, wherein the first connection lines are parallel with the second connection lines.

7. The touch module of claim 1, wherein a resistance difference between one of the first connection lines adjacent to the second connection lines and one of the second connection lines adjacent to the first connection lines is less than 200Ω.

8. The touch module of claim 7, wherein the first specified number is less than 120, and the second specified number is less than or equal to 120.

9. A touch display apparatus comprising:
a driver; and
a touch module coupled to the driver, the touch module comprising:
a matrix of electrode blocks comprising at least two electrode columns, each electrode column comprising N electrode blocks;
an insulating layer covered on the electrode blocks; the insulating layer with through holes at regions corresponding to the electrode blocks;
first connection lines disposed on a layer of the insulating layer facing away from the electrode blocks, and each first connection line configured to connect the driver with one of the electrode blocks through the through holes; and
second connection lines disposed on a layer of the insulating layer facing away from the electrode blocks, and each second connection line configured to connect the driver with one of the electrode blocks through the through holes;
wherein the driver is disposed on a side of the electrode blocks; in one electrode column, distances between the electrode blocks and the driver are gradually increased from the first electrode block to the Nth electrode block; the first to (M−1)th electrode blocks are respectively connected to the second connection lines, and the Mth to Nth electrode blocks are respectively connected to the first connection lines; the Mth electrode block is connected to the first connection line through the through holes in a first specified number, the (M+1)th to Nth electrode blocks are connected to the first connection line in a second specified number; the first specified number is less than the second specified number; M is less than N, and is larger than 1; M and N are integers;
wherein each first connection line comprises two conductive lines in parallel connection, the number of the conductive lines in each first connection line is constant the second connection line is a single conductive line; the conductive lines and the single conductive line are of a constant resistance.

10. (canceled)

11. The touch display apparatus of claim 9, wherein each first connection line has a specified number of the conductive lines.

12. The touch display apparatus of claim 9, wherein each electrode column has a specified number of the electrode blocks; a number of the electrode blocks connected to one of the first connection lines in one electrode column is equal to a number of the electrode blocks connected to one of the first connection lines in another electrode column; a number of the electrode blocks connected to one of the second connection lines in one electrode column is equal to a number of the electrode blocks connected to one of the second connection lines in another electrode column.

13. The touch display apparatus of claim 12, wherein in each electrode column, two thirds of the electrode blocks are respectively connected to the first connection lines, and one thirds of the electrode blocks are respectively connected to the second connection lines.

14. The touch display apparatus of claim 9, wherein the first connection lines are parallel with the second connection lines.

15. The touch display apparatus of claim 9, wherein a resistance difference between one of the first connection lines adjacent to the second connection lines and one of the second connection lines adjacent to the first connection lines is less than 200Ω.

16. The touch display apparatus of claim 9, wherein the first specified number is less than 120, and the second specified number is less than or equal to 120.

17. A touch module in a touch display apparatus, the touch display apparatus comprising a driver coupled to the touch module; the touch module comprising:
a matrix of electrode blocks comprising at least two electrode columns, each electrode column comprising N electrode blocks;
an insulating layer covered on the electrode blocks; the insulating layer with through holes at regions corresponding to the electrode blocks;
first connection lines disposed on a layer of the insulating layer facing away from the electrode blocks, and each first connection line is configured to connect the driver with one of the electrode blocks through the through holes; and
second connection lines disposed on a layer of the insulating layer facing away from the electrode blocks, and each second connection line is configured to connect the driver with one of the electrode blocks through the through holes;
wherein in one electrode column, the first to (M−1)th electrode blocks are respectively connected to the second connection lines, and the Mth to Nth electrode blocks are respectively connected to the first connection lines; each first connection line comprises at least two conductive lines in parallel connection manner; the second connection line is a single conductive line; the conductive lines and the single conductive line are in a constant resistance;
wherein each first connection line comprises two conductive lines in parallel connection, the number of the conductive lines in each first connection line is constant the second connection line is a single conductive line; the conductive lines and the single conductive line are of a constant resistance;
wherein the number of the through holes of the Mth electrode block connected to the first connection line is a first specified number, the number of the through holes of each of the (M+1)th to Nth electrode blocks connected to the first connection lines is a second specified number; the first specified number is less than the second specified number.

18. (canceled)

19. The touch module of claim 17, wherein in each electrode column, two thirds of the electrode blocks are respectively connected to the first connection lines, and one thirds of the electrode blocks are respectively connected to the second connection lines.

20. The touch module of claim 17, wherein a resistance difference between one of the first connection lines adjacent to the second connection lines and one of the second connection lines adjacent to the first connection lines is less than 200Ω.
